(19) United States
(12) Patent Application Publication
(10) Pub. No.: US 2026/0188056 A1
(43) Pub. Date: Jul. 2, 2026

(54) SYSTEMS AND METHODS FOR A VEHICLE DATA HUB

(71) Applicant: Quanata, LLC, San Francisco, CA (US)

(72) Inventors: Eric Christopher Dahl, Newman Lake, WA (US); Morgan Haire Bugbee, San Marino, CA (US); Paul Valentin Mederos, Santa Clara, CA (US); Kathryn M. Vadiver, San Jose, CA (US)

(73) Assignee: Quanata, LLC, San Francisco, CA (US)

(21) Appl. No.: 19/006,918

(22) Filed: Dec. 31, 2024

(51) Int. Cl. G07C 5/00; G06Q 30/0207; G06Q 40/08; G07C 5/08

(52) U.S. Cl. CPC G07C 5/006; G06Q 30/0207; G06Q 40/08; G07C 5/008; G07C 5/0808; G07C 5/0825

(57) ABSTRACT

A method can include: aggregating, from multiple sources into a data hub, vehicle-related data for a vehicle; performing an analysis of the vehicle-related data; generating a predictive maintenance recommendation based on the analysis of the vehicle-related data; transmitting the predictive maintenance recommendation to a mobile electronic device for display on a graphical user interface of the mobile electronic device to a user of the vehicle; receiving a reward to incentivize a recommended usage of the vehicle based on the analysis of the vehicle-related data; transmitting the reward to the mobile electronic device for display on the graphical user interface; automating a vehicle ownership task for the vehicle based on the analysis of the vehicle-related data; and transmitting the vehicle ownership task to the mobile electronic device for display on the graphical user interface. Other embodiments are disclosed.

### FIELD OF THE DISCLOSURE

The present disclosure generally relates to managing and using vehicle data.

### BACKGROUND

Vehicle ownership, maintenance, and use are integral to modern life, but managing various aspects of a vehicle can be complex and time-consuming, especially with more and more data being generated about the ownership, maintenance, and use of vehicles. Therefore, systems and methods are desired to manage and use vehicle data to facilitate the ownership, maintenance and use of a vehicle.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a front elevation view of a computer system that is suitable for implementing an embodiment of the system disclosed in FIG. 3;

FIG. 2 illustrates a representative block diagram of an example of the elements included on the circuit boards inside a chassis of the computer system of FIG. 1;

FIG. 3 illustrates a system for a vehicle data hub and use thereof, according to an embodiment;

FIG. 4 illustrates a flow chart for a method of using a vehicle data hub, according to an embodiment;

FIG. 5 illustrates a graphic user interface of a mobile electronic device, according to an embodiment;

FIG. 6 illustrates a flow chart of a first portion of the method of FIG. 4, according to an embodiment; and

FIG. 7 illustrates a flow chart of a second portion of the method of FIG. 4, according to an embodiment.

The figures depict embodiments for purposes of illustration only. One skilled in the art will readily recognize from the following discussion that other embodiments of the systems and methods illustrated herein can be employed without departing from the principles of the technology described herein.

### DETAILED DESCRIPTION OF THE DRAWINGS

Traditionally, vehicle owners have relied on a fragmented ecosystem of service providers, leading to inefficiencies and suboptimal decision-making. Connected car technologies and mobile devices have created new opportunities for gathering and analyzing vehicle-related data, but much of this data remains siloed within specific systems. Existing solutions for tracking vehicle maintenance or providing driving behavior feedback often lack integration with other aspects of vehicle ownership. The increasing complexity of modern vehicles, combined with growing emphasis on fuel efficiency and environmental impact, has created a need for more sophisticated management tools. As the automotive industry evolves with electric and autonomous vehicles, the landscape of vehicle ownership and management is becoming even more complex. Given these challenges and opportunities, there is growing demand for systems that can aggregate and analyze diverse sources of vehicle-related data, provide actionable insights to vehicle owners, and automate various aspects of vehicle ownership and maintenance.

The present embodiments can generally relate to a vehicle data hub, which can be useful for, inter alia, solving one or more of the following technical problems related to handling different types of vehicle-related data from different sources by using one or more of the following technical solutions. (1) Data format inconsistency: The embodiments can address the problem of disparate data formats from various sources by implementing a system and method that can revise and convert data into a common format. This revision and conversion can solve the technical challenge of integrating and analyzing data from multiple databases with potentially incompatible structures. (2) Data storage efficiency: By storing the aggregated data in a common format, the system and method can improve electronical memory storage efficiency. This improvement can solve the problem of redundant or inefficient data storage that can occur when maintaining multiple copies of data in different formats. (3) Data processing complexity: The common data format can allow for more efficient use of the stored data in subsequent processing and analysis. This efficiency can solve the technical problem of having to repeatedly transform or adapt data for each analysis task, which can be computationally expensive and time-consuming. (4) Scalability challenges: As the system and method aggregate data from at least two databases, the system and method can provide a scalable solution for handling increasing volumes and varieties of vehicle-related data. This scalability can address the technical problem of maintaining system performance and data accessibility as the number of data sources grows. (5) Data interoperability: By converting data from multiple sources into a common format, the embodiments can solve the problem of data interoperability. This solution can allow different components of the system to work with the data without needing to understand or accommodate multiple data formats. (6) Analytical efficiency: The common data format can enable more efficient data analysis, and can permit the systems and methods to more efficiently use the stored data. This solution can solve the technical problem of performance bottlenecks in data analysis pipelines caused by data format inconsistencies. (7) System complexity reduction: By standardizing the data format, the embodiments can reduce the overall complexity of the system. This reduction can address the technical challenge of maintaining and updating systems that need to work with multiple data formats simultaneously. These solutions can collectively enable a more robust, efficient, and scalable system for aggregating, storing, and analyzing vehicle-related data from diverse sources.

More specifically, some embodiments can include a method being implemented via execution of computing instructions configured to run on one or more processors and stored on one or more non-transitory computer-readable media. The method can include: aggregating, from multiple sources into a data hub, vehicle-related data for a vehicle; performing an analysis of the vehicle-related data; generating a predictive maintenance recommendation based on the analysis of the vehicle-related data; transmitting the predictive maintenance recommendation to a mobile electronic device for display on a graphical user interface of the mobile electronic device to a user of the vehicle; receiving a reward to incentivize a recommended usage of the vehicle based on the analysis of the vehicle-related data; transmitting the reward to the mobile electronic device for display on the graphical user interface of the mobile electronic device to the user of the vehicle; automating a vehicle ownership task for the vehicle based on the analysis of the vehicle-related data; and transmitting the vehicle ownership task to the mobile electronic device for display on the graphical user interface of the mobile electronic device to the user of the vehicle. The method can be configured to include additional, less, or other functionality, including the functionality discussed elsewhere herein.

In other embodiments, a system can be provided. The system can include one or more local or remote processors, servers, sensors, memory units, transceivers, mobile devices, wearables, smart watches, smart rings, smart glasses or contacts, augmented reality glasses, virtual reality headsets, mixed or extended reality headsets, voice bots, chat bots, artificial intelligence bots, and/or other electronic or electrical components, which can be in wired or wireless communication with one another. For instance, in one aspect, a computer system can include one or more local or remote processors and/or associated transceivers, along with one or more local or remote non-transitory computer-readable media storing computing instructions that, when run on the one or more processors, direct the one or more processors to perform one or more operations.

The operations can include: aggregating, from multiple sources into a data hub, vehicle-related data for a vehicle; performing an analysis of the vehicle-related data; generating a predictive maintenance recommendation based on the analysis of the vehicle-related data; transmitting the predictive maintenance recommendation to a mobile electronic device for display on a graphical user interface of the mobile electronic device to a user of the vehicle; receiving a reward to incentivize a recommended usage of the vehicle based on the analysis of the vehicle-related data; transmitting the reward to the mobile electronic device for display on the graphical user interface of the mobile electronic device to the user of the vehicle; automating a vehicle ownership task for the vehicle based on the analysis of the vehicle-related data; and transmitting the vehicle ownership task to the mobile electronic device for display on the graphical user interface of the mobile electronic device to the user of the vehicle. The operations can be configured to include additional, less, or other functionality, including the functionality discussed elsewhere herein.

In further embodiments, a non-transitory computer readable storage medium storing computing instructions can be provided. The computing instructions, when run on one or more processors, can cause the one or more processors to perform operations. The operations can include: aggregating, from multiple sources into a data hub, vehicle-related data for a vehicle; performing an analysis of the vehicle-related data; generating a predictive maintenance recommendation based on the analysis of the vehicle-related data; transmitting the predictive maintenance recommendation to a mobile electronic device for display on a graphical user interface of the mobile electronic device to a user of the vehicle; receiving a reward to incentivize a recommended usage of the vehicle based on the analysis of the vehicle-related data; transmitting the reward to the mobile electronic device for display on the graphical user interface of the mobile electronic device to the user of the vehicle; automating a vehicle ownership task for the vehicle based on the analysis of the vehicle-related data; and transmitting the vehicle ownership task to the mobile electronic device for display on the graphical user interface of the mobile electronic device to the user of the vehicle. The operations can be configured to include additional, less, or other functionality, including the functionality discussed elsewhere herein.

In other embodiments, a system can include a data fusion center configured to aggregate and store vehicle-related data from multiple sources. The system also can include an analytics engine configured to generate a predictive maintenance recommendation based on the aggregated data. The system can further include a rewards module configured to incentivize recommended vehicle usage and maintenance. The system can additionally include an artificial intelligence (AI) task automation module configured to automate vehicle ownership tasks. The system also can include an optical character recognition module configured to extract vehicle service information from user-uploaded images of vehicle service receipts.

Advantages will become more apparent to those skilled in the art from the following description of the embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

In some embodiments, the techniques described herein can provide one or more practical applications and technological improvements. For example, the techniques described herein can provide a technical improvement to data format inconsistency, data storage efficiency, data processing complexity, scalability challenges, data interoperability, analytical efficiency, and system complexity reduction, as explained herein. The techniques described herein also can provide improvement over conventional approaches that merely aggregates data.

Additionally, the techniques described herein can further provide improvement over conventional approaches that do not consider data format inconsistency, data storage efficiency, data processing complexity, scalability challenges, data interoperability, analytical efficiency, and/or system complexity reduction The techniques described herein can provide improvement over conventional approaches that do not perform one or more of the functions described herein.

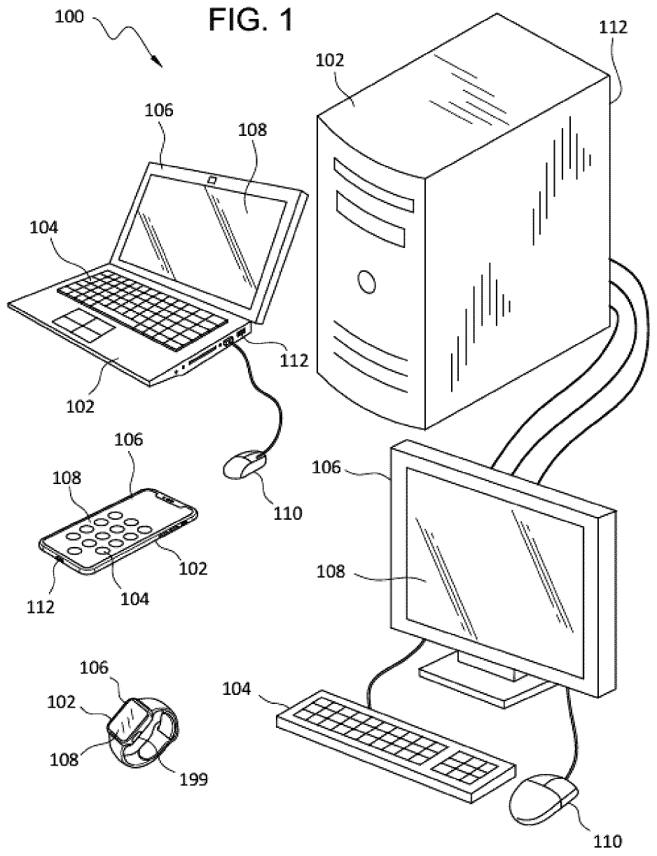

Turning to the drawings, FIG. 1 illustrates an embodiment of four different types (e.g., a laptop, a tower server, a smartphone, and a smartwatch) of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

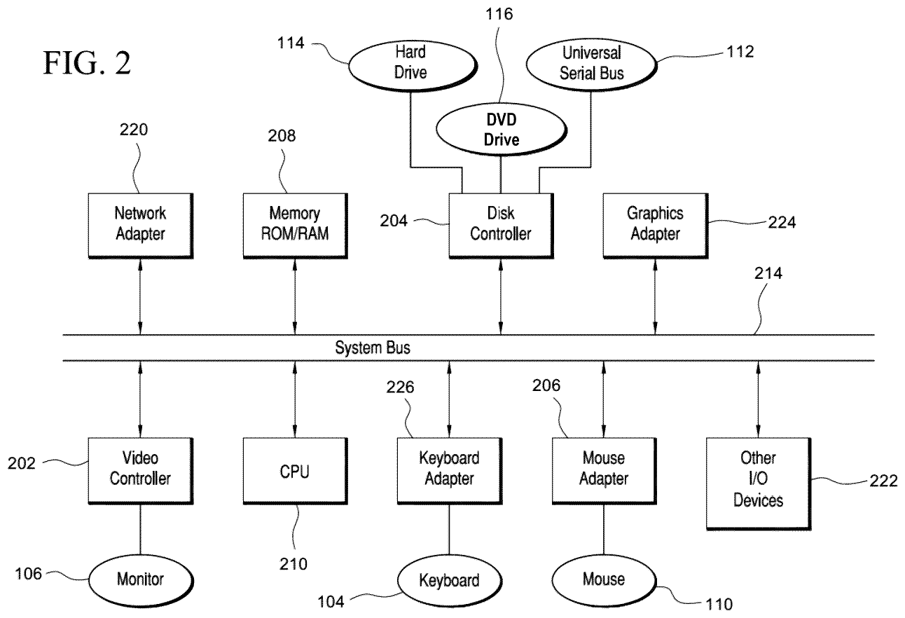

A representative block diagram of the elements included on the circuit boards inside chassis 102 is shown in FIG. 2. A central processing unit (CPU) 210 in FIG. 2 is coupled to a system bus 214. In some embodiments, the architecture of CPU 210 can be compliant with any of a variety of commercially distributed architecture families.

Continuing with FIG. 2, system bus 214 can also be coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in a CD-ROM and/or DVD drive 116 (FIG. 2) inside chassis 102 (FIG. 1) or in a detachable drive coupled to input/output port 112.

Non-volatile or non-transitory memory storage unit(s) refer to the portions of the memory storage units(s) that are non-volatile memory and not a transitory signal. In the same or different examples, the one or more memory storage units of some embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS by The Open Group Ltd. of Reading, Berkshire in the United Kingdom, and (iv) Linux® OS by Linus Torvalds of Boston, Massachusetts, United State of America.

Further operating systems can comprise one of the following: (i) the iOS® operating system by Apple Inc. of Cupertino, California, United States of America, (ii) the Blackberry® operating system by Research In Motion (RIM) of Waterloo, Ontario, Mayada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the embodiments disclosed herein can comprise CPU 210.

In the depicted embodiment of FIG. 2, various I/O (input/output) devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well-known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable CD-ROM and/or DVD drive coupled to input/output port 112, on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In some embodiments, computer system 100 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 100, and can be executed by CPU 210. In the same or different embodiments, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer, a tower server, or a mobile device in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, smart watch, smart rings, wearable, virtual reality headset, augmented reality glasses, etc. In certain additional embodiments, computer system 100 can comprise an embedded system.

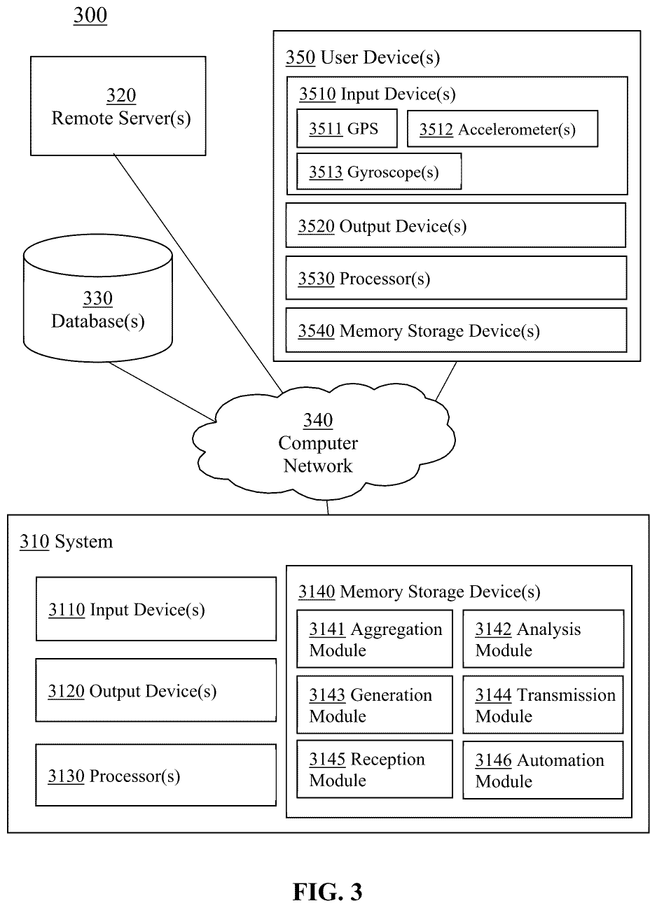

Turning ahead in the drawings, FIG. 3 illustrates a block diagram of a system 300 for a vehicle data hub and use thereof. System 300 can be for a vehicle data hub, which can be used to address technical problems of data format inconsistency, data storage efficiency, data processing complexity, scalability challenges, data interoperability, analytical efficiency, and/or system complexity reduction, according to certain embodiments. System 300 is not limited to the embodiments presented herein. The system can be employed in many different embodiments or examples not specifically depicted or described herein. In some embodiments, certain elements, modules, or systems of system 300 can perform various procedures, processes, operations, actions, and/or activities. In other embodiments, the procedures, processes, operations, actions, and/or activities can be performed by other suitable elements, modules, or systems of system 300.

Generally, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more databases (e.g., a database(s) 330), one or more remote servers (e.g., a remote server(s) 320), and one or more first user devices (e.g., a first user device(s) 350), and a computer system (e.g., system 310). Database(s) 330, remote server(s) 320, first user device(s) 350, and system 310 can each be a computer system, such as computer system 100 (FIG. 1), as described above, and can each be a single computer, a single server, or a cluster or collection of computers or servers, or a cloud of computers or servers. In another embodiment, a single computer system can host each of database(s) 330, remote server(s) 320, first user device(s) 350, and system 310.

In some embodiments, each of first user device(s) 350 can include modules of computing instructions (e.g., software modules) stored on non-transitory computer readable media (e.g., memory storage device(s) 3540) that operate on one or more processors (e.g., processor(s) 3530). In other embodiments, first user device(s) 350 can be implemented in hardware, including ASICs (application specific integrated circuits) and the like. In some embodiments, system 310 can comprise one or more systems, subsystems, modules, models, or servers (e.g., an aggregation module 3141, an analysis module 3142, a generation module 3143, a transmission module 3144, a reception module 3145, an automation module 3146, etc.). Each of aggregation module 3141, analysis module 3142, generation module 3143, transmission module 3144, reception module 3145, and automation module 3146 can be implemented, at least in part, in software and/or firmware stored in or loaded on one or more memory storage device(s) (e.g., memory storage device(s) 3140) of system 310 and executed on processor(s) 3130 of system 310. In some embodiments, one or more of aggregation module 3141, analysis module 3142, generation module 3143, transmission module 3144, reception module 3145, and automation module 3146 can include one or more of trained machine learning (ML) and/or artificial intelligence (AI) models (the ML/AI models).

In some embodiments, first user device(s) 350 can be in data communication, through a computer network, a telephone network, or the Internet (e.g., computer network 340), with remote server(s) 320, database(s) 330, and/or system 310. In other embodiments, first user device(s) 350 can be in direct communication with other components of system 300 using, for example, Bluetooth communication. In some embodiments, as explained below, first user device(s) 350 can be mobile device(s) (such as smartphone(s)) used by user(s), such as driver(s) or operator(s) of one or more vehicles.

In certain embodiments, first user device(s) 350, remote server(s) 320, and/or system 310 can host one or more websites and/or mobile application servers. For example, first user device(s) 350, remote server(s) 320, and/or system 310 can host a website, or provide a server that interfaces with an application (e.g., a mobile application or a web browser), on first user device(s) 350. In some embodiments, an internal network (e.g., computer network 340) that is not open to the public can be used for communications between first user device(s) 350, database(s) 330, remote server(s) 320, and/or system 310 within system 300.

In some embodiments, each of system 310 and first user device(s) 350 can include one or more input devices (e.g., input device(s) 3110 and 3510, respectively), one or more output devices (e.g., output device(s) 3120 and 3520, respectively), one or more processors (e.g., processor(s) 3130 and 3530, respectively), and/or one or more memory storage devices (e.g., memory storage device(s) 3140 and 3540, respectively). Examples of input device(s) 3110 and 3510 can include one or more keyboards, one or more keypads, one or more pointing devices such as a computer mouse or computer mice, one or more touchscreen displays, a microphone, a camera, keyboard 104 (FIG. 1), mouse 110 (FIG. 1), etc. Examples of output device(s) 3120 and 3520 can include one or more monitors, one or more touch screen displays, projectors, monitor 106 (FIG. 1), screen 108 (FIG. 1), etc. Other examples of output device(s) 3120 and 3520 can include other I/O device 222 (FIG. 2), network adapter 220, wireless transmitters, wired transmitters, and the like. Examples of processor(s) 3110 and 3530 can include CPU 210 (FIG. 2), etc. Examples of memory storage device(s) 3140 and 3540 can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc. In a number of embodiments, input device(s) 3110 and/or 3510 further can include one or more cameras and/or one or more microphones. In the same or different embodiments, input device(s) 3110 and/or 3510 can include one or more GPS (Global Positioning System) sensor(s) (e.g., GPS sensor(s) 3511), one or more accelerometers (e.g., accelerometer(s) 3512), one or more gyroscopes (e.g., gyroscope(s) 3513), and/or one or more magnometers, among other input devices.

Input device(s) 3510 and output device(s) 3520 can be coupled to first user device(s) 350 in a wired manner and/or a wireless manner, and the coupling can be direct and/or indirect, as well as locally and/or remotely. Similarly, input device(s) 3110 and output device(s) 3120 can be coupled to system 310 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple input device(s) 3110 and output device(s) 3120 to processor(s) 3130 and/or memory storage device(s) 3140. In some embodiments, the KVM switch also can be part of system 310. In a similar manner, processor(s) 3130 and/or memory storage device(s) 3140 can be local and/or remote to each other.

In certain embodiments, the user devices (e.g., first user device(s) 350) can be mobile devices, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, smart contacts, smart watches, smart rings, smart bracelets, other smart jewelry, smart headbands, augmented-reality (AR) headsets, virtual-reality (VR) headsets, etc.), or another portable computer device with the capability to present audio and/or visual data (e.g., images, videos, music, etc.). Thus, in some examples, a mobile device can include a volume and/or weight sufficiently small as to permit the mobile device to be easily conveyable by hand.

Mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Mayada, (iii) a Lumia® or similar product by the Nokia Corporation of Keilaniemi, Espoo, Finland, (iv) a Galaxy™ Tab, Smartphone or Ring or similar product by the Samsung Group of Samsung Town, Seoul, South Korea, and/or (v) an Oura® Ring or similar product by Oura Health Oy of Oulu, Finland. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Mayada, (iii) the Android™ operating system developed by the Open Handset Alliance, or (iv) the Windows Mobile™ operating system by Microsoft Corp. of Redmond, Washington, United States of America.

Meanwhile, in some embodiments, first user device(s) 350 also can be configured to communicate with one or more databases (e.g., a database(s) 330) and/or one or more remote server(s) 320. The one or more databases can include a connected car database, a vehicle telematics database, a mobile phone telematics database, a vehicle maintenance database, a vehicle accident database, an insurance claim database, an original equipment manufacturer (OEM) (such as a car manufacturer or an automobile parts manufacturer) database (which can include an OEM component recall database), and/or a manual user input database. The one or more databases also can include a member database that contains information about the demographic and/or geographic information of members of a population (e.g., insurance policyholders for an insurance company, etc.). The demographic and/or geographic information of the members can include the ages, genders, residences, insurance policies, premiums, payment history, and/or claim histories for the members, for example, among other information. The same or different databases can include telematics data for such members, and/or electronic ledgers related to the telematics data. The one or more databases additionally can include one or more of trained machine learning (ML) and/or artificial intelligence (AI) models (the ML/AI models) used in system 300, remote server(s) 320, first user device(s) 350, and/or system 310. The one or more databases further can include training datasets for various ML/AI models, modules, or systems. The training datasets can be obtained from a third party, generated manually, and/or curated from historical input/output data of one or more pre-trained ML/AI models, etc.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, first user device(s) 350, system 310, remote server(s) 320, and/or database(s) 330 can be implemented using any suitable manner of wired and/or wireless communication. Accordingly, system 300, first user device(s) 350, system 310, and/or database(s) 330 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). PAN protocol(s) can include Bluetooth, Zigbee, Wireless Universal Serial Bus (USB), Z-Wave, etc.; LAN and/or WAN protocol(s) can include Institute of Electrical and Electronic Engineers (IEEE) 802.3 (also known as Ethernet), IEEE 802.11 (also known as WiFi), etc.; and wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In some embodiments, communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further communication hardware can include wireless communication hardware including, for example, one or more radio transceivers, one or more infrared transceivers, etc. Additional communication hardware can include one or more networking components (e.g., modulator-demodulator components, gateway components, etc.).

In some embodiments, remote server(s) 320, first user device(s) 350, and/or system 310 can be configured to transmit, to a user device (e.g., system 310 transmit to first user device(s) 350, or first user device(s) 350 transmit to remote server(s) 320, etc.) of a user, a graphical user interface (e.g., a webpage, a graphical user interface of a mobile application, etc.) for display on the user device. The graphical user interface can include predictive maintenance recommendations, other recommendations, rewards, vehicle ownership tasks, statistics, warnings, notices, motivational messages, requests for user confirmation, discounts for insurance premiums, travel directions, and the like. Remote server(s) 320, first user device(s) 350, and/or system 310 can determine, by using any suitable approaches or ML/AI models, the statistics, warnings, recommendations, notices, motivational messages, requests, discounts, directions, and other information. Algorithms for the ML/AI models for determining the information can include decision trees, K Nearest Neighbor (KNN), neural networks, CatBoost, support vector machine, etc.

As an example, referring to FIG. 3, aggregation module 3141 of memory storage device(s) 3140 of system 310 can be configured to receive and collect vehicle-related data about a vehicle from multiple databases, and store the vehicle-related data in a common data format. Analysis module 3142 of memory storage device(s) 3140 of system 310 can be configured to analyze the vehicle-related data, as stored in the common data format. Generation module 3143 of memory storage device(s) 3140 of system 310 can be configured to determine a predictive maintenance recommendation based on the analysis of the vehicle-related data. Reception module 3145 of memory storage device(s) 3140 of system 310 can be configured to receive a reward to incentive a recommended usage of a vehicle based on the analysis of the vehicle-related data. Automation module 3146 of memory storage device(s) 3140 of system 310 can be configured to automate a vehicle ownership task for the vehicle based on the analysis of the vehicle-related data. Transmission module 3144 of memory storage device(s) 3140 of system 310 can be configured to transmit the predictive maintenance recommendation, the reward, and/or the vehicle ownership task to a user device, such as user device(s) 350. A user interface on output device(s) 3520 of memory storage device(s) 3140 of user device(s) 350 can be configured to display the predictive maintenance recommendation, the reward, and/or the vehicle ownership task to a user.

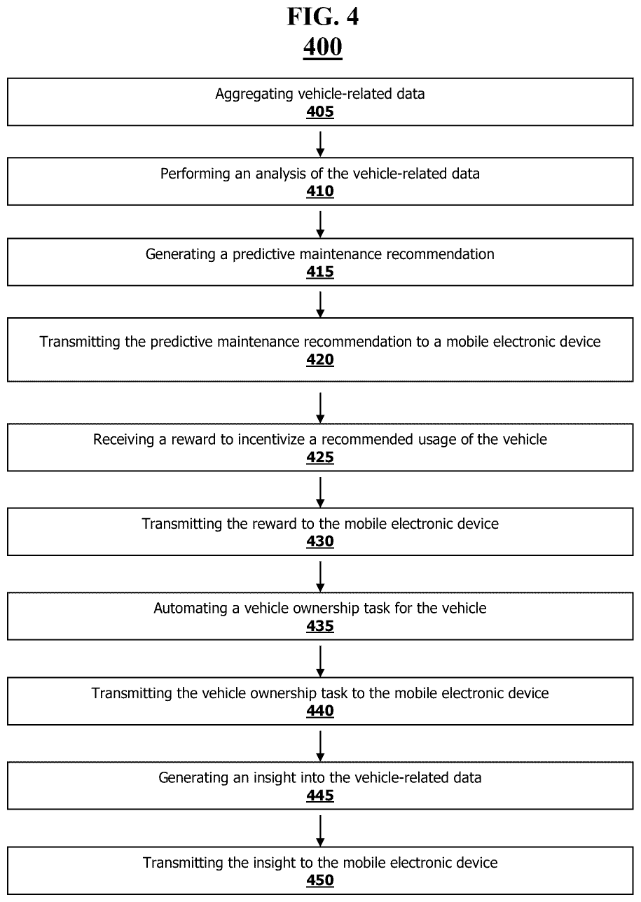

Turning ahead in the drawings, FIG. 4 illustrates a flow chart of a method 400 for using a vehicle data hub, which can be used to address technical problems of data format inconsistency, data storage efficiency, data processing complexity, scalability challenges, data interoperability, analytical efficiency, and/or system complexity reduction, according to certain embodiments. Method 400 can be implemented via execution of computing instructions configured to run on one or more processors and stored on one or more non-transitory computer-readable media, and/or via one or more ASICs. Method 400 is not limited to the embodiments presented herein. Method 400 can be employed in many different embodiments or examples not specifically depicted or described herein.

In some embodiments, the procedures, the processes, the operations, the actions, and/or the activities of method 400 can be performed in the order presented. In other embodiments, the procedures, the processes, the operations, the actions, and/or the activities of method 400 can be performed in any suitable order. In still other embodiments, one or more of the procedures, the processes, the operations, the actions, and/or the activities of method 400 can be combined together or skipped.

In some embodiments, system 300 (FIG. 3) or system 310 (FIG. 3) (including one or more of its elements, modules, and/or systems, such as aggregation module 3141 (FIG. 3), analysis module 3142 (FIG. 3), generation module 3143 (FIG. 3), transmission module 3144 (FIG. 3), reception module 3145 (FIG. 3), and automation module 3146 (FIG. 3) can be suitable to perform method 400 and/or one or more of the operations, actions, and/or activities of method 400. In these or other embodiments, one or more of the operations, actions, and/or activities of method 400 can be implemented as one or more computing instructions configured to run on one or more processors and configured to be stored on one or more non-transitory computer readable media, and/or as one or more ASICs. Such non-transitory computer readable media can be part of a computer system such as system 300 (FIG. 3), first user device(s) 350 (FIG. 3), system 310 (FIG. 3). The processor(s) can be similar or identical to the processor(s) described above with respect to computer system 100 (FIG. 1), processor(s) 3530 (FIG. 3), and/or processor(s) 3130 (FIG. 3).

Referring to FIG. 4, in some embodiments, method 400 can be implemented via execution of computing instructions configured to run on one or more processors and stored on one or more non-transitory computer-readable media. More specifically, method 400 can include a block 405 of aggregating vehicle-related data. Aggregating the vehicle-related data can include passively receiving and then storing the vehicle-related data in a data hub. Aggregating the vehicle-related data also can include actively receiving the vehicle-related data and then storing the vehicle-related data. Actively receiving the vehicle-related data can include accessing, collecting, or retrieving the vehicle-related data. Aggregating the vehicle-related data also can include continuously or periodically monitoring and/or updating the vehicle-related data in the data hub.

In some embodiments, storing the vehicle-related data can include associating the vehicle-related data with a vehicle, and not associating the vehicle-related data with an owner of the vehicle or a driver of the vehicle. In these embodiments, the vehicle-related data can stay associated with the vehicle even if the vehicle is sold or otherwise transferred to a new owner of the vehicle or a new driver of the vehicle. Also in these embodiments, a database separate from the data hub can be used to store telematics data of the driver of the vehicle, even though at least some of the telematics data might be duplicative with the vehicle-related data in the data hub. In other embodiments, storing the vehicle-related data can include associating the vehicle-related data with the owner of the vehicle or the driver of the vehicle, and not associating the vehicle-related data with the vehicle. In further embodiments, storing the vehicle-related data can include associating the vehicle-related data with the vehicle and one or more of the owner of the vehicle or the driver of the vehicle.

As noted above, in some embodiments, block 405 can include aggregating the vehicle-related data in a data hub. In the same or different embodiments, block 405 can include aggregating, from multiple sources into the data hub, the vehicle related data for a vehicle. As an example, the data hub can be database(s) 330 (FIG. 3) or a portion thereof.

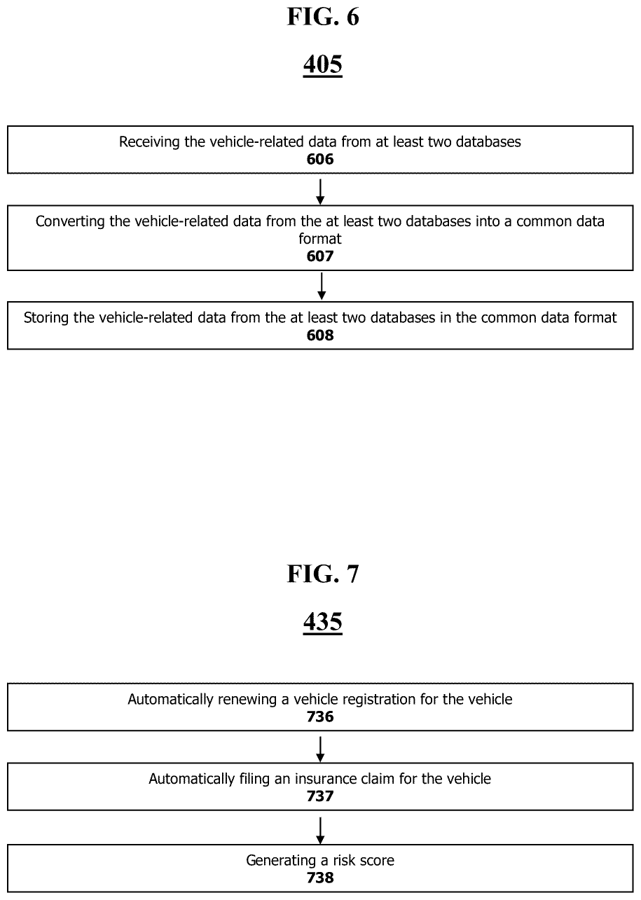

Jumping ahead in the drawings to FIG. 6, block 405 of method 400 (FIG. 4) can include a block 606 of receiving the vehicle-related data from at least two databases. As an example, the databases can include two or more of the following databases: connected car database(s), vehicle telematics database(s), mobile phone telematics database(s), vehicle maintenance database(s), vehicle accident database(s), insurance claim database(s), original equipment manufacturer (OEM) (such as a car manufacturer or an automobile parts manufacturer) database(s), and/or manual input database(s) (e.g., data input manually from an input device such as first user device(s) 350). The vehicle-related data from the connected car database can include data from an actual database and/or data from connected cars. Similarly, the vehicle-related data from the vehicle telematics database(s) can include data from an actual database and/or data from telematics system(s) of vehicle(s), and the mobile phone telematics database(s) can include data from an actual database and/or data from telematics system(s) of mobile phone(s). The vehicle-related data from the vehicle maintenance database(s) can include data from an actual database and/or data from vehicle maintenance and/or repair entity. The vehicle-related data from the vehicle accident database(s) can include data from an actual database and/or data from a police report, a police station, an insurance company, etc., and the vehicle-related data from the insurance claim database can include data from an actual database and/or data from one or more insurance companies. The vehicle-related data from the manual input database(s) can include data from an actual database and/or data from one or more graphical user interfaces (GUIs) on one or more mobile devices, such as images of vehicle service receipts, which can be processed (using optical character recognition, machine learning, etc.) to extract vehicle service information from user-uploaded images of the vehicle service receipts. As noted above for block 405 in FIG. 4, the receiving of block 606 in FIG. 6 can include passively receiving and/or actively receiving.

When system 310 (FIG. 3) aggregates data from various sources in block 405, system 310 (FIG. 3) can implement a data standardization process to ensure consistency and interoperability across the diverse datasets. This process can involve revising the original data formats into a unified, common data format. The common data format can be designed to accommodate the wide range of vehicle-related information while preserving the integrity and relationships within the data. For example, continuing with FIG. 6, block 405 of method 400 (FIG. 4) can continue with a block 607 for converting the vehicle-related data from the at least two databases into a common data format, and then block 405 can continue with a block 608 of storing the vehicle-related data from the at least two databases in the common data format.

More specifically, the data revision process can include several steps. (1) Data mapping: System 300 (FIG. 3) can create a comprehensive schema that maps fields from each source database to corresponding fields in the common format. This mapping can account for differences in naming conventions, data types, and hierarchical structures across the source databases. (2) Data cleaning: System 300 (FIG. 3) can perform data cleaning operations to address inconsistencies, errors, or missing values in the source data. This operation can involve techniques such as data validation, outlier detection, and imputation of missing values. (3) Data transformation: System 300 (FIG. 3) can apply various transformations to convert the data into the desired format. These transformations can include operations such as: date and time standardization, unit conversion (e.g., miles to kilometers), encoding categorical variables, and normalizing numerical values. (4) Data enrichment: System 300 (FIG. 3) can augment the data with additional information or derived features that enhance its value for analysis. This augmentation can include calculating aggregate statistics or joining data from multiple sources.

After the data is converted to the common format, system 300 (FIG. 3) can store the data in memory storage device(s) 3140 and/or database(s) 330 (FIG. 3). This technique can optimize the storage solutions for efficient data retrieval and analysis, potentially utilizing technologies such as columnar storage or indexing strategies tailored to the common data format.

The adoption of a common data format can offer several advantages. (1) Simplified data integration: Data from different sources can be combined and analyzed together. (2) Improved data quality: The standardization process can help identify and correct data quality issues. (3) Enhanced performance: Queries and analyses can be optimized or improved for a single, well-defined data structure. (4) Easier maintenance: Updates and modifications to the data processing pipeline can be simplified when working with a consistent format.

In the context of block 405 of method 400 in FIG. 4, the common data format can enable more efficient data processing and analysis. For example, machine learning models can be designed to work directly with the standardized data, reducing the need for preprocessing steps during analysis. Block 607 (FIG. 6) of block 405 can encompass the data conversion process, where vehicle-related data from at least two databases is transformed into the common data format. This conversion can involve applying the data mapping, cleaning, transformation, and enrichment steps to each source database. Following the conversion, block 608 (FIG. 6) can involve storing the standardized vehicle-related data in the common format. This storage step can include: (1) Writing the data to appropriate tables or collections in the chosen storage system; (2) Updating any necessary indexes or metadata to facilitate efficient data retrieval; and (3) Implementing data versioning or archiving strategies to maintain historical records of the original and converted data. By standardizing and storing data in this manner, system 300 (FIG. 3) can create a robust foundation for the subsequent analysis and processing steps in method 400, potentially leading to more accurate and insightful results from the vehicle data hub.

Next, returning to FIG. 4, method 400 can continue with a block 410 of performing an analysis of the vehicle-related data. This analysis can incorporate machine learning techniques and vector-based representations to process and interpret the complex, multi-dimensional data collected from various sources. In some embodiments, the analysis can begin by transforming the aggregated vehicle-related data into numerical representations, transforming the numerical representations into vector representations, and comparing the vectors to each other and/or to baseline vectors or other vectors. These vectors can encode diverse information such as vehicle telemetry, maintenance history, driver behavior, and environmental conditions into numerical formats suitable for machine learning algorithms. Each data point or feature may be represented as a dimension in a high-dimensional vector space, allowing for efficient computation and comparison. The analysis of block 410 can combine or concatenate these individual feature vectors to create comprehensive input vectors. These input vectors can serve as the foundation for various machine learning models, providing a holistic view of the vehicle's state, its operational context, and historical patterns.

The analysis of block 410 can employ a range of machine learning algorithms, which can include: (1) neural networks, which can be used to identify complex, non-linear relationships in the data; (2) decision trees, which can help to create interpretable rules and decision pathways; and/or (3) ensemble methods, such as random forests or gradient boosting machines, which can combine multiple models to improve prediction accuracy and robustness. These algorithms can process the input vectors to uncover patterns, correlations, and intricate relationships between different data elements. For example, the analysis can identify how specific driving behaviors correlate with maintenance needs, or how weather conditions interact with vehicle performance metrics. In some embodiments, the machine learning algorithms can learn from historical outcomes to generate recommendations and predictions. This learning process can involve training on past data where the outcomes are known, then applying the learned patterns to current data to make forward-looking assessments.

The analysis can generate new vectors representing the modeled data, and the modeled data vectors can be integrated with the original input data, creating a more comprehensive dataset for further analysis and decision-making. This integration can allow for a nuanced understanding of the current situation in the context of historical trends and predicted future states.

This vector-based approach can offer several advantages in processing multi-dimensional vehicle-related data, including (1) more efficient computation because vector operations can be highly optimized, allowing for rapid processing of large datasets; (2) dimensionality reduction because techniques like principal component analysis (PCA) can be applied to vectors to identify the most important features and reduce noise; and/or (3) similarity measurements because vector representations allow for easier calculation of similarities between different data points or scenarios using metrics like cosine similarity. This approach can enable the machine learning models to capture subtle interactions between various factors. The analysis also can incorporate techniques for handling temporal data, such as recurrent neural networks (RNNs) or long short-term memory (LSTM) networks, to capture time-dependent patterns in vehicle usage and performance. By leveraging these analytical techniques, the analysis of block 410 can provide insights into vehicle operation, maintenance needs, and risk factors, potentially enabling more informed decision-making for vehicle owners, fleet managers, individual vehicle owners, and others.

After block 410, method 400 can continue with a block 415 of generating a predictive maintenance recommendation. The generating also can include the use of machine learning techniques, as noted herein. The predictive maintenance recommendation can be based on the analysis of the vehicle-related data in block 410, including the historical maintenance data for the vehicle, as well as current usage patterns for the vehicle. The generating of block 415 can include generating a vehicle health score based on the analysis of the vehicle-related data.

Block 415 of method 400 in FIG. 4 also can include automatically arranging a vehicle maintenance appointment for the vehicle, as well as arranging transportation for the vehicle owner during the vehicle maintenance appointment. Block 415 also can include automatically scheduling a recall-related service for a component of the vehicle, which can be based on data from an OEM product recall database. Block 415 can further include automatically ordering replacement parts for the vehicle and to be used during for the vehicle maintenance appointment. As another example, block 415 can include automatically scheduling electrical vehicle charging for an electric vehicle based on the analysis of the vehicle-related data, including historic usage patterns of the vehicle, predicted usage of the vehicle, electricity pricing differences during the day, electric vehicle recharging station locations based on the predicted usage, and so on. As a further example, block 415 can include automatically scheduling vehicle refueling (e.g., gasoline, hydrogen, etc.) for the vehicle based on the analysis of the vehicle-related data, including historic usage patterns of the vehicle, predicted usage of the vehicle, gasoline, etc. station locations based on the predicted usage, fuel price differences at different gasoline, etc. stations based on the predicted usage, and so on.

Subsequently, method 400 in FIG. 4 can continue with a block 420 of transmitting the predictive maintenance recommendation to a mobile electronic device. In some embodiments, the predictive maintenance recommendation can be transmitted to the mobile electronic device for display on a graphical user interface of the mobile electronic device to a user of the vehicle. The transmission to the mobile electronic device also can include information about the automatically scheduled vehicle maintenance appointment, etc., as described with reference to block 415 above. In some embodiments, the completion of block 415 can trigger the performance of block 420. In some embodiments, block 420 can include automatically negotiating and securing lower rates for vehicle-related services based on the vehicle maintenance record of the vehicle from the vehicle data hub, as well as (optionally) a user's driving history stored in a different database.

Method 400 in FIG. 4 also can include a block 425 of receiving a reward to incentivize a recommended usage of the vehicle. The reward and/or the incentivization can be based on the analysis of the vehicle-related data in block 410. The analysis of the vehicle-related data can include vehicle usage patterns and vehicle maintenance patterns. A determination of which award to be used to incentivize a particular recommended usage of the vehicle in block 425 can be made based on the use of machine learning techniques, as noted herein. The recommended usage of the vehicle can include optimal or safe driving behaviors, timely vehicle maintenance, and/or eco-friendly vehicle usage. In some embodiments, block 425 can include receiving information about how and where to redeem the reward, among other information about the reward.

The reward can be from a third party to provide free or discounted services or products. As an example, the reward can be a discounted oil change to incentivize timely maintenance of the vehicle, and/or the reward can be a free brake pad with the purchase of one brake pad if the user operates the vehicle in a gentler manner with less hard braking and/or with beginning to brake further away from a stop sign or red traffic light. As another example, the reward can be a gasoline discount at a gasoline station if the user operates the vehicle in a more fuel-efficient manner such as driving without riding the brakes (e.g., driving without continuously keeping your foot slightly pressed on the brake pedal while driving, which applies a light braking force for extended periods of time and can lead to excessive brake wear and is considered a poor driving habit). Further examples of a reward can include lower vehicle loan payments and/or reduced or discounted insurance premiums to incentivize safer driving.

Subsequently, method 400 in FIG. 4 can continue with a block 430 of transmitting the reward to the mobile electronic device. In some embodiments, the reward can be transmitted to the mobile electronic device for display on the graphical user interface of the mobile electronic device to the user of the vehicle. The transmission to the mobile electronic device also can include information about how to redeem the reward, etc., as described with reference to block 425 above. In some embodiments, the completion of block 425 can trigger the performance of block 430.

Method 400 in FIG. 4 also can include a block 435 of automating a vehicle ownership task for the vehicle. The automation can include the use of machine learning techniques, as noted herein. The vehicle ownership task can be based on the analysis of the vehicle-related data in block 410, including the historical maintenance data for the vehicle, as well as current usage patterns for the vehicle. Block 435 can be limited to initiating the automation of the vehicle ownership task, or can include the complete automation of the vehicle ownership task.

Turning ahead in the drawings to FIG. 7, block 435 of method 400 (FIG. 4) can include a block 736 of automatically renewing a vehicle registration for the vehicle. The renewing can be based on the analysis of the vehicle-related data in block 410 (FIG. 4). The renewing in block 736 also can be based on local regulations such as state laws, etc. In some embodiments, the renewing can include automatically arranging an appointment for vehicle emissions testing when needed.

Block 435 of method 400 (FIG. 4) in FIG. 7 also can include a block 737 of automatically filing an insurance claim for the vehicle, and/or a block 738 of generating a risk score. The filing of block 737 and/or the generating of block 738 can be based on the analysis of the vehicle-related data in block 410 (FIG. 4). In some embodiments, block 435 in FIG. 7 includes none or only one of blocks 736, 737, or 738. In other embodiments, block 435 includes two or more of blocks 736, 737, or 738.

When block 435 in FIG. 7 includes block 738 of generating the risk score, block 738 can further include automatically shopping for vehicle insurance rates based on the risk score, and performing a comparison of the vehicle insurance rates. In this embodiment, block 738 also can include transmitting the comparison of the vehicle insurance rates to the mobile electronic device. The transmission can be for display on the graphical user interface of the mobile electronic device to the user of the vehicle. In some embodiments, block 738 additionally can include receiving, from the mobile electronic device, a selection of an insurance policy based on the comparison of the vehicle insurance rates. Moreover, in some embodiments, block 738 can include automatically enrolling the user of the vehicle in the insurance policy, as selected. In these embodiments, insurance companies can have access to the risk score generated in block 738, the analysis of the vehicle-related data in block 410 (FIG. 4), and/or the vehicle related data aggregated in block 405 (FIG. 4), and the insurance companies can use this information to determine the vehicle insurance rates.

In addition to or instead of blocks 736, 737, and/or 738 in FIG. 7, block 435 can include optimizing the vehicle ownership task based on user schedules and preferences when the vehicle data hub is used with a smart home system. Additionally, in some embodiments, in addition to or instead of blocks 736, 737, and/or 738 in FIG. 7, block 435 can include an automatic vehicle resale process based on market conditions and the analysis of the vehicle-related data.

Returning to FIG. 4, after block 435, method 400 can continue with a block 440 of transmitting the vehicle ownership task to the mobile electronic device. In some embodiments, the vehicle ownership task can be transmitted to the mobile electronic device for display on the graphical user interface of the mobile electronic device to the user of the vehicle. The transmission to the mobile electronic device also can include the other information described with reference to block 435 in FIG. 7 above. In some embodiments, the completion of block 435 can trigger the performance of block 440.

Method 400 in FIG. 4 also can include a block 445 of generating an insight into the vehicle-related data. The generating the insight can include the use of machine learning techniques, as noted herein. The insight can be based on the analysis of the vehicle-related data in block 410, including the telematics data for the vehicle, historical maintenance data for the vehicle, current usage patterns of the vehicle, and so on. As an example, the insight can include a depreciation in value of the vehicle, and/or an environmental impact of the vehicle due to vehicle emissions and other byproducts and effects from vehicle usage. As another example, the insight can include a comparison of an aspect of the vehicle with one or more similar vehicles and/or with one or more users operating the one or more similar vehicles where the one or more users have similar user profiles as the user of the vehicle. As a further example, the insight can include information regarding how the user can increase the fuel-efficiency of the vehicle (e.g., by accelerating more slowly) and/or how the user can increase the life of the brake pads and tires (e.g., by decelerating more slowly).

After block 445 in FIG. 4, method 400 can continue with a block 450 of transmitting the insight to the mobile electronic device. In some embodiments, the insight can be transmitted to the mobile electronic device for display on the graphical user interface of the mobile electronic device to the user of the vehicle. The transmission to the mobile electronic device also can include the other information described with reference to block 445 above. In some embodiments, the completion of block 445 can trigger the performance of block 450.

In different embodiments, method 400 can include blocks 405, 410, 415, and 420 but not blocks 425, 430, 435, 440, 445, or 450; or method 400 can include blocks 405, 410, 425, and 430 but not blocks 415, 420, 435, 440, 445, or 450; or method 400 can include blocks 405, 410, 435, and 440 but not blocks 415, 420, 425, 430, 445, or 450; or method 400 can include blocks 405, 410, 445, and 450 but not blocks 415, 420, 425, 430, or 440. In other embodiments, method 400 can include only two or three of (a) blocks 415 and 420, (b) blocks 425 and 430, (c) blocks 435 and 440, or (d) blocks 445 and 450.

In some embodiments, the insights generated in block 445 can be used in (a) block 415 to generate the predictive maintenance recommendation, (b) block 425 to determine the reward to incentivize the recommended usage of the vehicle, and/or (c) block 435 to identify the vehicle ownership task to be automated. In these embodiments, block 445 of generating the insight can be performed as part of or after block 410 of performing the analysis of the vehicle-related data, or block 445 of generating the insight can be performed before or as part of block 415 of generating the predictive maintenance recommendation, block 425 of determining the reward to incentivize the recommended usage of the vehicle, and/or block 435 of identifying the vehicle ownership task to be automated.

In some embodiments, the aggregating the vehicle-related data of block 405, the performing the analysis of the vehicle-related data of block 410, the generating the predictive maintenance recommendation of block 415, the transmitting the predictive maintenance recommendation of block 420, the receiving the reward to incentivize a recommended usage of the vehicle of block 425, the transmitting the reward of block 425, the automating the vehicle ownership task of block 435, the transmitting the vehicle ownership task of block 440, the generating the insight of block 445, and the transmitting the insight of block 450 can be performed for vehicles of a fleet of vehicles. In these embodiments, the fleet of vehicles can be owned by a business, such as a delivery company or a shipping company, and method 400 in FIG. 4 can be used to manage the fleet of vehicles.

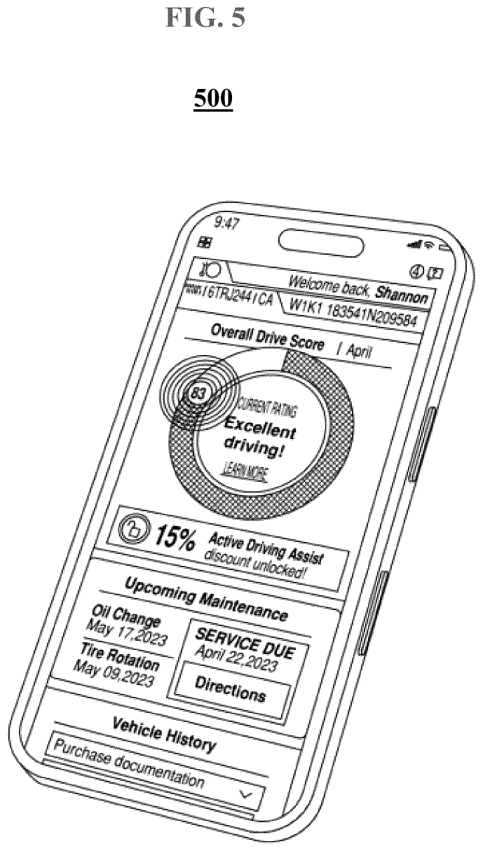

Turning to FIG. 5, a graphic user interface (GUI) 500 of a mobile electronic device, according to an embodiment, is illustrated. As shown in FIG. 5, the GUI 500 includes a risk score (“CURRENT RATING Excellent driving!”), a reward (“15% . . . discount unlocked!”) to incentivize a recommended usage of the vehicle (“Active Driving Assist”), predictive maintenance recommendations (“Upcoming Maintenance”, “Oil Change”, “Tire Rotation”, “SERVICE DUE”), among other information.

Relating FIGS. 4, 6, and 7 to FIGS. 1, 2, and 3, as an example, input device(s) 3510, output device(s) 3520, processor(s) 3530, and/or memory storage device(s) 3540 (FIG. 3) can perform all or a portion of blocks 405, 420, 425, 430, 435, 440, 450 (FIG. 4), blocks 606, 607, 608 (FIG. 6), and/or blocks 736, 737, 738 (FIG. 7); input device(s) 3110 (FIG. 3) can perform all or a portion of blocks 405, 425 (FIG. 4), blocks 606, 607, 608 (FIG. 6), and/or blocks 736, 737, 738 (FIG. 7); processor(s) 3130 and memory storage device(s) 3140 (FIG. 3) can perform all or portions of blocks 405, 410, 415, 420, 425, 430, 435, 440, 445, 450 (FIG. 4), blocks 606, 607, 608 (FIG. 6), and/or blocks 736, 737, 738 (FIG. 7); output device(s) 3120 (FIG. 3) can perform all or a portion of blocks 420, 430, 440, and/or 450; remote server(s) 320 (FIG. 3) can perform all or portions of blocks 405, 410, 415, 420, 425, 430, 435, 440, 445, 450 (FIG. 4), blocks 606, 607, 608 (FIG. 6), and/or blocks 736, 737, 738 (FIG. 7); database(s) 330 can perform all or portions of blocks 405, 410, 415, 420, 425, 430, 435, 440, 445, 450 (FIG. 4), blocks 606, 607, 608 (FIG. 6), and/or blocks 736, 737, 738 (FIG. 7); aggregation module 3141 can perform all or a portion of block 405 (FIG. 4) and/or blocks 606, 607, 608 (FIG. 6); analysis module 3142 (FIG. 3) can perform all or a portion of blocks 410 and/or 445 (FIG. 4); generation module 3143 (FIG. 3) can perform all or a portion of blocks 415 and/or 445 (FIG. 4); transmission module 3144 (FIG. 3) can perform all or a portion of block 420, 430, 440, and/or 450 (FIG. 4); reception module 3145 (FIG. 3) can perform all or a portion of blocks 435, 445 (FIG. 4), and/or blocks 736, 737, 738 (FIG. 7); and automation module 3146 (FIG. 3) can perform all or a portion of blocks 440 and/or 445 (FIG. 4).

In a number of embodiments where one or more ML/AI models are used in blocks 410, 415, 425, 435, and/or 445 (FIG. 4), method 400 (FIG. 4) can further include pre-training and/or re-training the trained ML/AI models based upon the collected sensor data from blocks 405 (FIG. 4), feedback received from a system user (e.g., a data scientist, a machine learning engineer, etc.) or collected from various data sources (e.g., telematics databases, policy renewal rates, insurance claim trends, insurance premium trends, insurance premium discount trends, etc.), and/or synthesized training data. In these embodiments, the same or different ML/AI models can be used in one or more of blocks 410, 415, 425, 435, and/or 445 (FIG. 4).

For each of the machine learning models to be retrained, the respective training datasets can be updated manually by a system user (e.g., an ML engineer, a data scientist, etc.) and/or automatically by a system (e.g., system 300, system 310, or remote server(s) 320 (FIG. 3)). The system user can select new training data from various data sources (e.g., websites, books, magazines, product catalogs, private third-party databases, etc.). The system can collect new training data based upon various criteria. In certain embodiments, historical input and/or output data of the model to be re-trained can be used for re-training the model. In some embodiments, the historical input and/or output data of the model can be selected based upon system performance and/or user feedback from the system user associated with the historical output data. Examples of the user feedback can include when the machine learning model generates a predictive maintenance recommendation that is not correct, promotes a reward that does not incentivize the recommended usage of the vehicle, incorrectly automates the vehicle ownership task, generates an incorrect insight, and so forth. In some embodiments, when more than one training dataset is used for the pre-training and/or re-training, the system (e.g., system 300, system 310, and/or remote server(s) 320 (FIG. 3)) can format or re-format the data of the more than one training dataset (especially when datasets are from different sources) so that the hierarchy, schema, and/or other aspects of the data of the more than one training dataset follow a common hierarchy, structure, schema, etc., and so that the data of the more than one training dataset can be more easily used to pre-train or re-train the one or more machine learning models. The system can pre-determine the common hierarchy, structure, schema, etc. As needed, the system can reformat the data from various training dataset into a common data format so that the data can be used properly and efficiently by the system.

In some embodiments, the machine learning models, AI algorithms, classifiers, etc. can be customized and/or fine-tuned for the user. For example, customized classifiers can be trained, retrained, and stored locally on system 310 (FIG. 3). As another example, one or more of these customized classifiers can be trained and/or retrained remotely (e.g., at remote server(s) 320 (FIG. 3)) and stored locally on system 310 (FIG. 3).

Examples of the algorithms used for the various ML/AI models for one or more of the above-mentioned procedures, processes, activities, actions, operations, and/or methods can include BERT (Bidirectional Encoder Representations from Transformers), LLM (Language Learning Models), Lambda, Palm, XLNet, GPT-3 (generative pre-training transformer), GPT-4, KNN (k-nearest neighbor), decision trees, linear regression, logistic regression, K-Means, neural networks, fuzzy logic, GANs (generative adversarial networks), CTGAN (cloud transformer generative adversarial networks), CNNs (convolutional neural networks), VAEs (variational autoencoder), and so forth. In some embodiments, each of the ML/AI models used can be trained and/or retrained dynamically and/or regularly.

In some embodiments, the systems and/or methods can be configured to train or re-train the one or more ML/AI models. The training of each of the ML/AI models can be supervised, semi-supervised, and/or unsupervised - which in some embodiments can be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In some embodiments, the trained and/or re-trained ML/AI model as well as the training datasets can be stored in, updated, and accessed from a database (e.g., database(s) 330 (FIG. 3)). In the same or different embodiments, when more than one training dataset is used for the pre-training and/or re-training, the data of the more than one training dataset can be formatted or reformatted so that the hierarchy, schema, and/or other aspects of the data of the more than one training dataset (especially when datasets are from different sources) follow a common hierarchy, structure, schema, etc., and so that the data of the more than one training dataset can be more easily used to pre-train or re-train the one or more machine learning models. In some embodiments, the common hierarchy, structure, schema, etc. can be predetermined.

In some embodiments, the users, systems, and/or methods further can determine whether to add the newly created historical input and/or output data to the training dataset for retraining the ML/AI models based upon user feedback, predetermined criteria, and/or confidence scores for the historical output data. The user feedback can be associated with the output data of the ML/AI models or the output of the systems and/or methods using the ML/AI models.

In certain embodiments where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In some embodiments, the one or more ML/AI models can be configured to start or stop automatically upon occurrence of predefined events and/or conditions. In certain embodiments, the systems and/or methods can use a pre-trained ML/AI model, without any re-training.

Although systems and methods for collecting data have been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIGS. 1-7 can be modified, and that the foregoing discussion of certain of these embodiments does not necessarily represent a complete description of all possible embodiments. Additionally, one or more of the procedures, processes, operations, actions, and/or activities of the methods in FIGS. 4, 6, and 7 can include different procedures, processes, actions, and/or activities and be performed by many different modules, in many different orders. For example, the systems and methods described herein use multi-variate processes, but also can use mono-variate processes. Furthermore, the systems and methods are described herein for using a vehicle data hub, and can be integrated with an OEM database or receive data from the OEM to provide up-to-date information on recalls and technical service bulletins for the vehicle. In some embodiments, the OEM has access to the data in the vehicle data hub so that the OEM can improve designs of new versions of the vehicle or other vehicles. In some embodiments, the vehicle data hub can be changed to be a house data hub for a house where the house data hub can be associated with or disassociated with an owner of the house. In other embodiments, the vehicle data hub can be changed to be a life data hub for a user's body and/or life. Moreover, the systems and methods described herein can be to schedule carpooling and/or generate travel routes and driving times.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM (erasable programmable read-only memory) memory, EEPROM (electrically erasable programmable read-only memory) memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an embodiment, the system can be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method being implemented via execution of computing instructions configured to run on one or more processors and stored on one or more non-transitory computer-readable media, the method comprising:
aggregating, from multiple sources into a data hub, vehicle-related data for a vehicle;
performing an analysis of the vehicle-related data;
generating a predictive maintenance recommendation based on the analysis of the vehicle-related data;
transmitting the predictive maintenance recommendation to a mobile electronic device for display on a graphical user interface of the mobile electronic device to a user of the vehicle;
receiving a reward to incentivize a recommended usage of the vehicle based on the analysis of the vehicle-related data;
transmitting the reward to the mobile electronic device for display on the graphical user interface of the mobile electronic device to the user of the vehicle;
automating a vehicle ownership task for the vehicle based on the analysis of the vehicle-related data; and
transmitting the vehicle ownership task to the mobile electronic device for display on the graphical user interface of the mobile electronic device to the user of the vehicle.

2. The method of claim 1, wherein:
aggregating the vehicle-related data comprises:
receiving the vehicle-related data from at least two databases comprising: a connected car database, a vehicle telematics database, a mobile phone telematics database, a vehicle maintenance database, a vehicle accident database, or an insurance claim database;
converting the vehicle-related data from the at least two databases into a common data format; and
storing the vehicle-related data from the at least two databases in the common data format.

3. The method of claim 1, wherein:
automating the vehicle ownership task comprises at least one of:
automatically renewing a vehicle registration for the vehicle; or
automatically filing an insurance claim for the vehicle.

4. The method of claim 1, wherein:
automating the vehicle ownership task comprises:
generating a risk score based on the analysis of the vehicle-related data.

5. The method of claim 4, further comprising:
automating the vehicle ownership task further comprises:
automatically shopping for vehicle insurance rates based on the risk score;
performing a comparison of the vehicle insurance rates;
transmitting the comparison of the vehicle insurance rates to the mobile electronic device for display on the graphical user interface of the mobile electronic device to the user of the vehicle;
receiving, from the mobile electronic device, a selection of an insurance policy based on the comparison of the vehicle insurance rates; and
automatically enrolling the user of the vehicle in the insurance policy.

6. The method of claim 1, further comprising:
generating an insight into the vehicle-related data, based on the analysis of the vehicle-related data; and
transmitting the insight to the mobile electronic device for display on the graphical user interface of the mobile electronic device to the user of the vehicle.

7. The method of claim 1, wherein:
the aggregating, the performing, the generating, the transmitting the predictive maintenance recommendation, the receiving, the transmitting the reward, the automating, and the transmitting the vehicle ownership task are performed for vehicles of a fleet of vehicles; and
the fleet of vehicles is owned by a business.

8. A system comprising:
one or more processors; and
one or more non-transitory computer-readable media storing computing instructions that, when run on the one or more processors, cause the one or more processors to perform:
aggregating, from multiple sources into a data hub, vehicle-related data for a vehicle;
performing an analysis of the vehicle-related data;
generating a predictive maintenance recommendation based on the analysis of the vehicle-related data;
transmitting the predictive maintenance recommendation to a mobile electronic device for display on a graphical user interface of the mobile electronic device to a user of the vehicle;
receiving a reward to incentivize a recommended usage of the vehicle based on the analysis of the vehicle-related data;
transmitting the reward to the mobile electronic device for display on the graphical user interface of the mobile electronic device to the user of the vehicle;
automating a vehicle ownership task for the vehicle based on the analysis of the vehicle-related data; and
transmitting the vehicle ownership task to the mobile electronic device for display on the graphical user interface of the mobile electronic device to the user of the vehicle.

9. The system of claim 8, wherein:
aggregating the vehicle-related data comprises:
receiving the vehicle-related data from at least two databases comprising: a connected car database, a vehicle telematics database, a mobile phone telematics database, a vehicle maintenance database, a vehicle accident database, an insurance claim database, or a manual user input;
converting the vehicle-related data from the at least two databases into a common data format; and
storing the vehicle-related data from the at least two databases in the common data format.

10. The system of claim 8, wherein:
automating the vehicle ownership task comprises at least one of:
automatically renewing a vehicle registration for the vehicle; or
automatically filing an insurance claim for the vehicle.

11. The system of claim 8, wherein:
automating the vehicle ownership task comprises:
generating a risk score based on the analysis of the vehicle-related data.

12. The system of claim 11, wherein:
automating the vehicle ownership task further comprises:
automatically shopping for vehicle insurance rates based on the risk score ;
performing a comparison of the vehicle insurance rates;
transmitting the comparison of the vehicle insurance rates to the mobile electronic device for display on the graphical user interface of the mobile electronic device to the user of the vehicle;
receiving, from the mobile electronic device, a selection of an insurance policy based on the comparison of the vehicle insurance rates; and
automatically enrolling the user of the vehicle in the insurance policy.

13. The system of claim 8, wherein the computing instructions, when run on the one or more processors, cause the one or more processors to further perform:
generating an insight into the vehicle-related data, based on the analysis of the vehicle-related data; and
transmitting the insight to the mobile electronic device for display on the graphical user interface of the mobile electronic device to the user of the vehicle.

14. The system of claim 8, wherein:
the aggregating, the performing, the generating, the transmitting the predictive maintenance recommendation, the receiving, the transmitting the reward, the automating, and the transmitting the vehicle ownership task are performed for vehicles of a fleet of vehicles ; and
the fleet of vehicles is owned by a business.

15. A non-transitory computer readable storage medium storing computing instructions, the computing instructions, when run on one or more processors, causing the one or more processors to perform:
aggregating, from multiple sources into a data hub, vehicle-related data for a vehicle;
performing an analysis of the vehicle-related data;
generating a predictive maintenance recommendation based on the analysis of the vehicle-related data;
transmitting the predictive maintenance recommendation to a mobile electronic device for display on a graphical user interface of the mobile electronic device to a user of the vehicle;
receiving a reward to incentivize a recommended usage of the vehicle based on the analysis of the vehicle-related data;
transmitting the reward to the mobile electronic device for display on the graphical user interface of the mobile electronic device to the user of the vehicle;
automating a vehicle ownership task for the vehicle based on the analysis of the vehicle-related data; and
transmitting the vehicle ownership task to the mobile electronic device for display on the graphical user interface of the mobile electronic device to the user of the vehicle.

16. The non-transitory computer readable storage medium of claim 15, wherein:
aggregating the vehicle-related data comprises:
receiving the vehicle-related data from at least two databases comprising: a connected car database, a vehicle telematics database, a mobile phone telematics database, a vehicle maintenance database, a vehicle accident database, an insurance claim database, or a manual user input;
converting the vehicle-related data from the at least two databases into a common data format; and
storing the vehicle-related data from the at least two databases in the common data format.

17. The non-transitory computer readable storage medium of claim 15, wherein at least one of:
(a) automating the vehicle ownership task comprises at least one of:
automatically renewing a vehicle registration for the vehicle; or
automatically filing an insurance claim for the vehicle; or
(b) the aggregating, the performing, the generating, the transmitting the predictive maintenance recommendation, the receiving, the transmitting the reward, the automating, and the transmitting the vehicle ownership task are performed for vehicles of a fleet of vehicles; and
the fleet of vehicles is owned by a business.

18. The non-transitory computer readable storage medium of claim 15, wherein:
automating the vehicle ownership task comprises:
generating a risk score based on the analysis of the vehicle-related data.

19. The non-transitory computer readable storage medium of claim 18, wherein:
automating the vehicle ownership task further comprises:
automatically shopping for vehicle insurance rates based on the risk score ;
performing a comparison of the vehicle insurance rates;
transmitting the comparison of the vehicle insurance rates to the mobile electronic device for display on the graphical user interface of the mobile electronic device to the user of the vehicle;
receiving, from the mobile electronic device, a selection of an insurance policy based on the comparison of the vehicle insurance rates; and
automatically enrolling the user of the vehicle in the insurance policy.

20. The non-transitory computer readable storage medium of claim 15, wherein the computing instructions, when run on the one or more processors, cause the one or more processors to further perform:
generating an insight into the vehicle-related data, based on the analysis of the vehicle-related data; and
transmitting the insight to the mobile electronic device for display on the graphical user interface of the mobile electronic device to the user of the vehicle.
